(19) United States
(12) Patent Application Publication
(10) Pub. No.: US 2006/0179992 A1
(43) Pub. Date: Aug. 17, 2006

(54) Microtome

(76) Inventor: Omid Kermani, Koln (DE)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/541,248

(22) PCT Filed: Dec. 29, 2003
(86) PCT No.: PCT/EP03/14951

§ 371 Date: Jul. 1, 2005

(30) Foreign Application Priority Data
Jan. 4, 2003 (DE) 103 00 091.7

(51) Int. Cl. B26D 1/00

(52) U.S. Cl. 83/651

(57) ABSTRACT

The invention relates to a microtome, comprising a holding device with a support (3) for holding at least one portion of a processed object (4), and a severing means (6, 10, 13). Known microtomes of the aforementioned type have the disadvantage that the processed object must be fixed and there is limited freedom in the choice of guiding the cut. The invention avoids these disadvantages by the severing means comprising at least one laser radiation source (10) and means for focussing (6; 13) the laser radiation, and the beam focus (22) which has been produced by the focussing can be moved relative to the support (3) and can be guided to a location of the parting surface (19; 20) of the processed object (4) in order to effect severing of the material at this site. The invention furthermore relates to a process for microtomy which can be advantageously carried out with the microtome as claimed in the invention.

### FIELD OF THE INVENTION

The invention relates to a microtome with a holding device with a support for holding at least one portion of a processed object, and a severing means. Another aspect of the invention relates to a process for microtomy of a processed object.

### BACKGROUND OF THE INVENTION

Microtomes of the aforementioned type and the corresponding processes for microtomy are used to cut thin slices off a processed object which is to be studied in order to study it for example by means of a microscopic process. Microtomes are often used to obtain thin tissue sections from a tissue sample which can be studied by a transmitted light microscope.

In the prior art microtomes are known which contain a clamping device for the processed object and a blade which can be moved relative to this clamping device. The blade is mounted to be able to move easily on a carriage and the cutting edge of the blade can be moved back and forth in a parting plane. The processed object can be clamped in the clamping device and moved together with the support of the clamping device perpendicular to the parting plane.

The microtomy process with the known microtome is carried out such that the processed object is moved by a sliding motion which is pointed perpendicular to the parting plane into a position relative to the parting plane such that when the carriage with the blade moves in the parting plane, a thin slice is cut off from the processed object. The blade is returned to its initial position afterwards and the processed object is positioned relative to the blade in the vertical direction to the parting plane by a generally very small sliding feed motion <10 μm of the support such that a thin slice is cut off from the processed object in turn when the blade is moved again.

This process is generally repeated several times until a thin slice has been obtained from the area of the processed object which is to be studied.

To prevent the processed object from deforming in the cutting process with the known microtome, it is generally necessary to stabilize and/or support the processed object by means of additional measures. These additional measures include low-temperature cooling of processed objects with a deformation capacity which can be reduced by cooling before microtomy. The disadvantage in this process is that the so-called frozen sections which have been obtained from frozen processed objects generally do not show many details of the processed object and moreover artifacts are produced in the processed object by freezing. Another disadvantage of freezing is that deformation of the processed object and of the thin slice which has been cut off cannot be completely avoided by freezing. Moreover, the freezing of the processed object requires additional cost; this prevents prompt preparation of slices which can be viewed under a microscope and makes preparation altogether expensive.

Furthermore, one measure for supporting a processed object is to embed it in an embedding material. For processed objects in the form of tissue samples it is generally necessary to completely impregnate the processed object with the embedding material in order to achieve sufficient stabilization of the sample.

Paraffins and various plastics are known as embedding materials. To achieve impregnation, removing the water or fixing agent contained in the processed object from it in a multistage chemical process and replacing it by a fluid which can be easily mixed with the embedding material are known. Following this, impregnation with the embedding material in the liquid state, optionally one which has been liquefied by heating, can be carried out, and then the embedding material can be stabilized, for example, by cooling from a preheated state or by a chemical crosslinking reaction.

Embedding or impregnation with an embedding material is more time-consuming and complex with respect to the process engineering effort than freezing of the processed object. Embedding or impregnation often causes a change of the processed object so that upon later study of the slices obtained, artifacts are observed. These artifacts are typically the shrinkage or expansion of the sample. In the case of tissue samples changes of the sample caused by stopping or influencing the metabolic processes in the tissues also generally occur.

The thin sections obtained with known microtomes must often be subsequently processed. Thus, microdissection of these sections is known. In a microdissection, using a focussed laser beam an area of the sample section is outlined with a two-dimensional movement and in this way the outlined area of the section is removed from the entire sample section. This microdissection process is known for example from WO 97/29354. The process of microdissection does enables removal of the area which is to be microdissected from a section, but it is necessary beforehand to produce this section by microtomy of the sample. In this prior microtomy the above described disadvantages occur, such as for example the necessity of stabilizing or embedding the processed object.

### SUMMARY OF THE INVENTION

The object of the invention is to make available a microtome and a process for microtomy which enables careful microtomy of the processed object.

The object is attained as claimed in the invention by a microtome of the initially named type in which the severing means comprises at least one laser radiation source and means for focussing the laser radiation, the beam focus which has been produced by focussing being movable relative to the support and being guidable to a site on the parting surface of the processed object in order to cause material to be severed at this site. The microtome as claimed in the invention furthermore comprises means for pulsed delivery of the beam focus to the site of the parting surface, which means are set up so as to produce pulses with a length of action of <1 picosecond (1×10⁻¹² seconds).

The length of action is defined as the time for which the beam focus is acting at the site of the parting surface. The energy which is necessary per laser pulse for cutting is in the range of one picojoule (pJ) up to one millijoule (mJ), preferably in the range of several picojoules. A pulse energy of 100 nanojoules (nJ) has likewise proven advantageous.

A length of action of less than one picosecond, a so-called ultrashort pulse, has proven especially advantageous for most materials (especially biological tissues). Lengths of action which can technically be achieved at present are in the range down to twenty femtoseconds (20×10⁻¹⁵ seconds), but also, if technically feasible, even shorter lengths of action for the microtome as claimed in the invention can reasonably be used. The frequency of the acting pulse is preferably above 1000 Hertz. In particular, it has proven effective if the pulse frequency is above 100,000 Hertz. It is especially preferred if the pulse frequency is between 100 kHz and 10 MHz.

The length of action and pulse frequency which are usable for the process as claimed in the invention and the device as claimed in the invention can be varied in a wide range without the process as claimed in the invention no longer being able to be carried out by the variation. In particular the pulse duration and the pulse frequency can be matched to the material which is to be microtomed.

In doing so the length of action of the pulse can be longer or shorter than the pause between the pulses or can agree with it, a pulse duration being preferred which is shorter than the pause between two pulses.

If a relatively short pulse duration in the range of a few femtoseconds is chosen, the pulse frequency can be varied within a wide range. Thus, for example, at a pulse duration of 100 fs, pulse frequencies of for example 1 kHz, but also 1 MHz can be accomplished.

The material is severed in the microtome as claimed in the invention by local heating of the material by way of the process of multiphoton absorption at the site of the parting surface to which the beam focus is guided, and a resulting gasification/vaporization of the material is achieved. In addition to this desirable primary effect, so-called optical breakthrough, secondary side effects can also take place. Especially at high pulse energies, in the individual case side effects can occur, such as larger gas and cavitation bubbles which have a surface/volume ratio which is small compared to small gas bubbles and thus may release their gas contents only slowly to the environment. This would be disadvantageous for the desired cutting effect. Furthermore, the larger gas and cavitation bubbles could cause deformations and hinder precise positioning of the beam focus and thus precise cutting guidance. In addition, within the processed object pressure waves could occur which could possibly adversely affect the precision of the cutting process.

The photodisruptive effect, that is to say the desired cutting action of the laser beam, generally requires a specific minimum intensity at the site of the parting surface. Typically this intensity for processed objects of transparent material is approximately 1012 W/cm2 or more. The secondary side effects are conversely independent of the laser intensity, but are dependent on laser energy, and their extent and their number increase with increasing laser energies. Therefore, in order to reduce or prevent the secondary effects, it is accordingly advantageous to achieve low laser energy and high laser intensity. This can be attained for example by pulsed delivery of the beam focus to the location of the parting surface.

These adverse effects can be avoided or at least reduced by the pulsed delivery of the beam focus. Here it is especially advantageous if the beam focus pulses have high intensities, but little energy, i.e., the energy of the pulse is concentrated on a small volume, since in this way adverse side effects, such as the above described generation of larger gas and cavitation bubbles, can be avoided. Depending on the processed object and the set severing parameters, partial or complete separation at the site of the parting surface which is located in the region of the beam focus can be produced by a single pulse. Afterwards, in the case of only partial local separation, by the action of one or more pulses at the same site of the parting surface complete severance can be achieved; after relative movement of the support to the beam focus, material separation can be produced in turn at an adjacent site, by which a continuous cut can be made along the parting surface.

The microtome as claimed in the invention causes material separation by the action of the beam focus of a laser beam. This action causes local heating of the material of the processed object and as a result of this heating a local transition of the material into the gaseous state. In the relative motion between the beam focus and the support (with the processed object) the beam focus acts on several sites of the parting surface which are adjacent to one another, so that a continuous cut can be made.

The microtome as claimed in the invention avoids the danger of deformation of the processed object or the thin slice which is cut off the processed object, as occurs in the known microtomes which work with blades or knives, due to the cutting force. It is therefore unnecessary when using the microtome as claimed in the invention to embed,. impregnate or in some other way stabilize and/or support the processed object before microtomy. Artifacts as a result of the effects of an embedding material or a freezing process are thus avoided. The microtome as claimed in the invention allows free guidance of cutting.

One surprising advantage of the microtome as claimed in the invention is that the microtome also makes it possible to sever living tissue and in doing so obtain thin slices in vital form.

The laser radiation source of the microtome as claimed in the invention preferably emits laser radiation with a wavelength in the visible (VIS) or near infrared (NR) spectral range, that is to say, for example, between approximately 700 nm to 1400 nm, so that the laser radiation undergoes only low attenuation, for example due to absorption/scattering, within a conventional processed object.

Preferably in all three directions of space relative motion between the beam focus and the support can be carried out. To do this, for example, there can be a 3-D movement means which is connected to the support. With the microtome as claimed in the invention cutting can be guided in a manner which is much more variable than in known microtomes by the three-dimensional, relative mobility of the beam focus to the support and thus to the processed object which is held by the support. Thus, for example it is possible to remove a thin slice from the surface of the processed object by producing a first parting surface area which is parallel to the object's surface and a second parting surface area which lies perpendicular to the object's surface and which borders the first parting surface region. Furthermore, it is no longer necessary, as in known microtomes, to always cut off the entire plane of the parting surface of the studied object which extends as far as the edges of the processed object, but also partial areas (for example, areas with rectangular or round contours) can also be separated from such a parting surface plane. In this way very careful preparation of a processed object is possible, in which only the parts which are important to examination are separated from the processed object.

The penetration depth of the beam focus of the laser radiation is dependent on the absorption capacity of the material/materials of the processed object for the laser radiation which is used for cutting. The laser radiation source of a microtome as claimed in the invention is preferably designed such that the material can still be severed at a penetration depth of ≧10 μm relative to biological tissue as the processed object. This penetration depth corresponds to or even exceeds the thickness of the slice which is required for a microscopic examination. In many biological tissues, cutting to a depth of 2 mm and more is possible with the microtome as claimed in the invention.

Depending on the properties of the processed object, especially on its absorption capacity, it is also possible with the device as claimed in the invention to sever material at a distance from the surface of the processed object which exceeds the ordinary thickness of a thin slice which is to be produced for study. In this way, with the microtome as claimed in the invention, slices can be obtained from a great depth of the study object much more efficiently than is possible with the known microtome since by cutting off many thin slices up to the desired depth, it is not necessary to do anything beforehand.

In one advantageous embodiment of the microtome as claimed in the invention, the means for focussing the laser radiation are set up to move the beam focus in at least one direction of space relative to the support. Thus, for example, by setting up the focussing means to change the divergence/convergence of the laser beam and thus the focal length, and/or by the focussing means themselves being movable relative to the support, simple relative motion of the beam focus which can be precisely controlled to the support (and the pertinent processed object) along the beam direction can be achieved. Preferably the means for focussing of the laser beam comprise optical media which can slide or swivel, for example mirrors and/or lenses, in order to effect relative motion of the beam focus in one, two or three directions of space. Thus, for example, to change the location of the beam focus an optical medium can be moved into the laser beam, or an optical medium which is located in the laser beam and which shortens or lengthens the optical path length can be tilted.

In another advantageous embodiment there are means for guiding the laser radiation in order to move the beam focus in at least one direction of space relative to the support. These means can be configured for example as mirrors which can be swiveled around one or two axes.

The means for guiding the laser radiation can be advantageously combined with the above described means for moving the support. Thus for example one component of the direction of movement can implemented by means of guidance of the laser beam and the other two components of the direction of motion by means of movement of the support. Likewise it is advantageous to implement two components of the direction of motion by means of guidance of the laser beam and the remaining third component by means of movement of the support.

It is furthermore advantageous to provide both means for guiding the laser beam and also means for relative motion between the support and optics for the relative motion of the beam focus to the support in one or more directions of space. In this way for example coarse and fine adjustment can be achieved by the corresponding different means for relative motion.

In another advantageous embodiment, the means for focussing of the laser radiation have a numerical aperture ≧0.65. preferably a numerical aperture ≧1.2. One important advantage when using the indicated large numerical apertures is that a high focussing angle is achieved and in the areas of the laser radiation which are located in the beam direction upstream or downstream of the beam focus there is a radiation energy density which is only small relative to the radiation energy density in the beam focus, by which the material is severed in a sharply delineated manner in the area of the beam focus and is prevented from being severed in the areas in front and behind.

The means for pulsed delivery can interact with the laser radiation source in another advantageous embodiment. Thus for example, using means for pulsing interruption of the energy supply of the laser radiation source pulsed laser radiation can be produced and thus pulsed delivery of the beam focus to the location of the parting surface can be achieved.

The means for pulse delivery can work especially according to the principle of “chirped pulse” amplification. Reference is made to DE 100 20 559 and especially to paragraph (0009) and to the publication named there, D. Strickland, G. Mourou, Opt. Commun. 56. 219 (1985) on the principle of “chirped pulse” amplification.

The means for pulsed delivery in one advantageous embodiment of the microtome as claimed in the invention can be set up to interrupt a continuously generated laser beam in a pulsed manner and/or to route it away from the location of the parting surface in a pulsed manner. Without interrupting the emission of laser radiation from a laser radiation source, this achieves pulsed delivery of the beam focus to the location of the parting surface. The beam can be advantageously absorbed. But the beam can also be alternatively reflected and thus can be deflected away from the location of the parting surface to a location outside of the processed object or to a location on the processed object which is not relevant to the intended study of the processed object.

In another advantageous embodiment of a microtome with pulsed delivery of the beam focus, there are control means which control the time sequence of the radiation pauses and/or which are connected to means for detecting the time sequence of the radiation pauses and/or which control the relative motion between the beam focus and the support depending on the time sequence of the radiation pauses. The control means are used for synchronization of the laser beam pulses with relative motion between the beam focus and the support. Here the “time sequence” of the radiation pauses is defined as the duration and the frequency of the radiation pauses. When these control means are used, depending on the sequence of the radiation interruptions or radiation actions, the motion between the support and the beam focus and in this way the length of action of the individual pulse of laser radiation on the locations of the parting surface which are to be severed are controlled. In doing so the control means can control either (a) the time sequence of the radiation pulses and the relative motion or (b) simply detect the time sequence of the radiation pulses and control the relative motion depending on it. For control type (b) for example it is possible to react to pulse sequences which vary depending on the load and the energy supply of the laser radiation source.

Furthermore, there can be control means which are connected to means for detecting the relative motion between the beam focus and the support and which control the time sequence of the radiation pauses depending on the relative motion. This embodiment is especially advantageous when manual control of the relative motion by the user of the microtome takes place. These control means are also used for synchronization of the laser beam pulses with the relative motion between the beam focus and the support. Thus, depending on the manually controlled relative motion, the action or interruption of the pulsed laser radiation can be controlled by the control means. In this way it is possible to prevent failure of severing or incomplete severing in the parting surface with high-speed relative movements, since the pulse frequency or the length of action can be increased in this case. Furthermore, delivery of overly high radiation energy to one site when relative motion is absent or slow can be prevented, since in this case the control means can reduce the frequency and/or the length of action or can completely prevent the action of the beam focus on the site of the parting surface.

In another advantageous embodiment there are means for controlling the relative motion between the support and the beam focus along a curved parting surface. To control the relative motion along the curved parting surface, it is generally necessary to execute the relative motion in at least two, generally three directions of space. The relative motion can be achieved by means for guiding or means for focussing the laser radiation or by a movement means which interacts with the support or the laser radiation source, or a combination of the aforementioned means. With an advantageous embodiment, a thin slice parallel to the surface can be severed from study objects with a curved surface. Furthermore, this embodiment results in that a thin slice which lies in any orientation and configuration in the processed object can be cut off the latter.

Relative motion between the beam focus and the support can take place automatically or manually. Manual control can take place for example by way of a control unit which interacts with the control means, for example a joystick, which allows the user manual control of the relative motion by the focussing means, the guiding means and/or the movement means.

The microtome as claimed in the invention advantageously comprises means for observing the processed object. The observation means can be configured for example as a magnifying glass, microscope or the like. They are used for example to prepare the material severing process by defining the orientation and shape of the parting surface and consequently by executing relative motion between the beam focus and support using the observation means. Furthermore, the observation means can be used to observe the material severing process itself in order to for example to monitor the automatically executed relative motion or to manually control the relative motion.

The observation means can comprise especially an optical microscope which can be operated according to the incident light or transmitted light process. An optical microscope with a beam axis which is approximately parallel to the beam axis of the laser beam in the area of the beam focus, especially for example which coincides with it, is especially well suited. Furthermore, an optical microscope which can work both as a transmitted light and incident light microscope is especially suitable in order to thus be able to use the microscopy method which is suitable at the time, depending on the composition of the processed object, therefore especially its geometrical dimensions and absorption properties for the radiation used for observation.

Furthermore, the observation means can contain means for display of at least one section of the processed object using backscattered laser radiation. In this way observation of the processed object can be observed in a simplified manner without additional illumination means.

The aforementioned display means can comprise especially a detector for detection of the radiation which has been backscattered from a portion of the processed object, means of detecting the coherent radiation which has been reflected from the reference plane, and means for producing an image of the portion of the processed object by superposition of the laser radiation which has been backscattered from a portion of the processed object and the coherent radiation which is reflected from the reference plane. This embodiment is especially advantageous when the intensity of the individual laser pulses can be set such that a material-severing effect (a “photodisruptive effect) does not occur and especially the intensity of the laser pulses for purposes of display of the processed object can be set to be less than for purposes of severing the material. Display of the sample with the method of optical coherence tomography (OCT) is achieved by the indicated features. A detailed description of the OCT display process can be taken from DE 100 20 559 A1, especially its paragraphs 0037, 0038, and 0041-0051.

With reference to this patent disclosure document, the OCT process can be briefly summarized as an imaging process in which coherent radiation, such as for example laser radiation, is divided, the first part of the laser radiation being directed at the object to the imaged, in this case the processed object, and the second part is directed at the reference plane. The portions of radiation which are reflected by the object to be imaged and the reference plane are detected and brought into congruence, and by three-dimensional scanning of the object to be imaged a three-dimensional representation can be produced by detecting the interference of the superimposed pulses by means of a photodetector.

Using the OCT process, structures with a resolution of up to 1 μm can be displayed. The OCT process has a penetration depth which is dependent on the absorption capacity of the studied material. Generally a penetration depth of >2 mm is achieved even in highly scattering tissues.

Another aspect of the invention is a process for microtomy with the features as claimed in claim 14. The process is especially suited to being executed with the microtome as claimed in the invention.

Some advantageous forms of the process are given in claims 15-22 and correspond to execution of the process by means of advantageous embodiments of the microtome as claimed in the invention. Reference is made to the description above in this respect.

In many cases it is advantageous if in a first phase of the cutting process one or more regions of the parting surface which are spaced apart from one another are severed and in the last phase of the cutting process complete severing along the parting surface takes place by severing the areas which lie between the spaced regions. The division of the separation process into a first phase and a last phase, the last phase possibly being for example a second phase which directly follows the first phase, is advantageous for preventing deformations during the severing process and for preventing deformations of the thin slice which has been cut off.

In the first phase, severing of the material is produced preferably at several locally delineated areas. Unrepeated areas or “bridges” remain between these delineated areas. These bridges securely hold the slice which has been only partially cut off after the first phase on the processed object and thus prevent deformation of the slice. In the following phases of the severing process, the bridges are then severed in a concerted manner, which due to the stabilized forms of the processed object and the stabilized location of the slice which is to be cut off can be precisely detected by the beam focus within the processed object.

Furthermore, this development of the process prevents large amounts of energy from being delivered into a narrowly delineated area, which avoids disadvantages such as formation of large gas or cavitation bubbles and changes of the material of the processed object as a result of thermal effects. In particular, the small gas bubbles in the area of the regions which have been cut through in the first phase can be released to the environment when severing takes place in the last phase.

Another aspect of the invention is the use of a device which comprises a holding device with a support for holding at least one portion of a processed object, and a severing means, at least one laser radiation source and means for focussing of the laser radiation, the beam focus which is produced by focussing being movable relative to the support, and with a capacity to be guided to one location of the parting surface of the processed object in order to cause severing of the material at this location, for microtomy of the processed object.

This manner of using the above described device enables freely selectable guidance of cutting in the course of microtomy. A cut can be made at a freely selectable depth of the processed object and with a freely selectable location, these parameters being able to be influenced by the aperture and the beam absorption properties of the tissue which is to be cut. The cutting surface need not be flat in this manner of use, but can be irregular and/or curved. Fixing of the processed object is not necessary.

### BRIEF DESCRIPTION OF THE FIGURES

One advantageous embodiment of the microtome as claimed in the invention is described below with reference to the attached figures.

FIG. 1 shows a schematic of the microtome as claimed in the invention and

FIG. 2 shows a schematic cross section of a processed object on a support.

### DETAILED DESCRIPTION

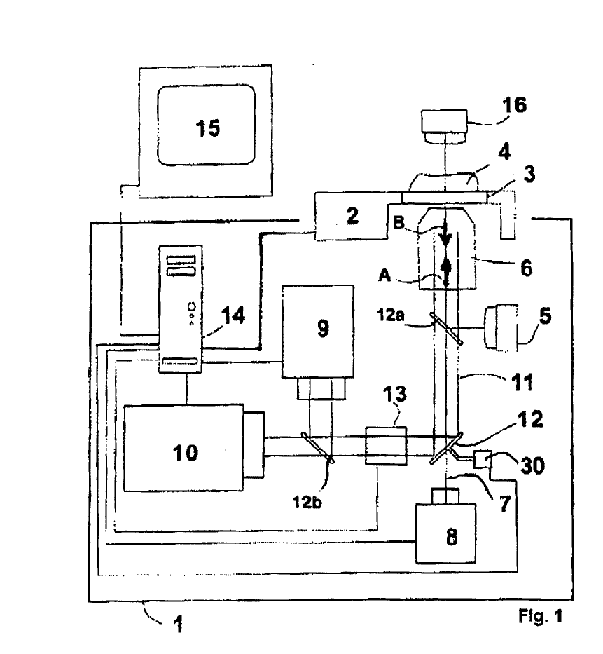

The microtome shown in FIG. 1 has a glass plate 3 as a support for the processed object (“sample”) 4. The glass plate 3 is connected to an XYZ traversing unit 2. By placing the sample 4 on the glass plate 3, for soft, flexible samples, advantageous smoothing is achieved. This smoothing action can optionally be intensified by a second glass plate (not shown) by the sample being inserted and pressed between this second glass plate and the glass plate 3.

On one side of the glass plate 3 there is a focussing objective lens 6 which has several lenses which are configured in the manner of a telescope (not shown). The distance of the lenses to one another and the distance of the lenses to the glass plate 3 can be varied. In this way the divergence/convergence of the laser beam 11 which runs through the focussing objective lens 6 is changed. The optical axis 7 of the focussing objective lens 6 is perpendicular to the plane of the glass plate 3.

Likewise, in the optical axis 7 of the focussing objective lens 6 on the side of the glass plate 3 opposite the focussing objective lens 6 there is an additional light source 16. The additional light source 16 is used to illuminate the sample 4 for display of the sample or parts of the sample by means of an optical transmitted light microscopy process.

The XYZ traversing unit 2 is attached to a housing 1. The additional light source 16 is likewise to attached to this housing 1. Within the housing 1 are the focussing objective lens 6 and a laser generator 10 with a laser radiation source which emits the laser beam 11. The laser beam 11 runs first approximately parallel to the plane of the glass plate 3, is deflected by approximately 90° thereto by means of a partially transmitting mirror 12, and thereafter runs coaxially to the optical axis of the focussing objective lens 6.

By swiveling or sliding the mirror 12, the laser beam can be angled to the optical axis 7 and thus the focus of the laser beam can be shifted in the directions which are parallel to the plane of the glass plate 3. A movement means 30 is attached to the mirror 12 and can push and swivel the mirror. Preferably the mirror can be swiveled around two axes which are perpendicular to one another, with an intersection point which lies preferably on the center axis of the laser beam 11. The movement means 30 is connected to a computer 14 which controls the swiveling of the mirror 12 and thus the deflection angle of the laser beam by the mirror 12. Swiveling of the mirror 12 from the position which is shown in FIG. 1 causes the beam characteristic to change in the area between the mirror 12 and the sample 4. Thus in particular the laser beam no longer runs coaxial to the optical axis of the focussing objective lens 6.

Between the partially transmitting mirror 12 and the laser generator 10 with the laser radiation source there is a prefocussing means 13 in the beam axis of the laser beam 11 which enables the divergence or convergence of the laser beam to be changed. By changing the divergence or convergence the location of the beam focus in the radiation direction downstream of the focussing objective lens 5 can be shifted along the optical axis of the focussing objective lens 6. The prefocussing means 13 consists of several lenses (not shown), preferably of two lenses, which are configured in the manner of a telescope, and with a distance to one another which can be changed, in order to thus change the divergence/convergence of the laser beam.

Between the partially transmitting mirror 12 and the focussing objective lens 8 there is a partially transparent illuminating mirror 12a in the path of the laser beam 11. The illuminating mirror 12a projects the light which is emitted from a light source 5 which is located next to the laser beam for illumination of the sample onto the latter in order to enable microscopic display of the sample 4 by means of the incident light microscopy process.

The laser beam 11 is not deflected by the partially transmitting illumination mirror 12a, but penetrates this illumination mirror in the direction to the focussing objective lens 6.

Downstream of the partially transmitting mirror 12 in the optical axis 7 there is a digital camera 8. This digital camera 8 detects the radiation reflected by the sample 4 and the radiation which has been emitted by the additional light source 16 and which has passed through the sample. The digital camera 8 is connected to the computer 14 which processes the image data which have been transmitted from the camera 8 and outputs a display of the sample 4 on a monitor 15.

Instead of the camera 8, there can also be an eyepiece means (not shown) which enables direct viewing of the sample. Furthermore, there can be an eyepiece means with a digital camera 8 attached to it which enables both direct viewing and also viewing of the sample on the monitor.

Between the prefocussing means 13 and the laser generator 10 with the laser radiation source there is a partially transmitting deflection mirror 12b in the path of the laser beam 11. The partially transmitting deflection mirror 12b branches off one part of the laser radiation which has been reflected from the study object 4 into the OCT detector unit 9. The OCT detector unit 9 is connected to the computer 14 and transmits image data to this computer 14 which computes from them a representation of the sample by means of the method of optical coherence tomography and outputs this representation on the monitor 15. Alternatively, this representation of the sample by means of the method of optical coherence tomography can be computed in the OCT detector unit 9 and then can be displayed directly on the display screen or the like or can be transmitted to the computer for purposes of display.

The computer 14 is used moreover to control the relative motion between the beam focus and the glass plate 3 which is used as a support for the sample 4. For this purpose, the computer 14 is connected to the prefocussing means 13, the movement means 30 and the XYZ traversing unit 2.

Furthermore, the computer 14 controls the connection and disconnection of the laser generator 10 with the laser radiation source and the pulsed action of the beam focus of the laser beam on the location of the parting surface of the sample 4. For this purpose the computer 14 is connected to the laser generator 10 with the laser radiation source.

Therefore the computer 14 can likewise matching between the pulsed laser radiation, i.e., the pulse frequency and the length of action, and the relative motion between the beam focus and sample or glass plate 3 which is achieved by moving the XYZ traversing unit, changing the convergence/divergence in the prefocussing means 13 and/or swiveling/sliding the movement means 30.

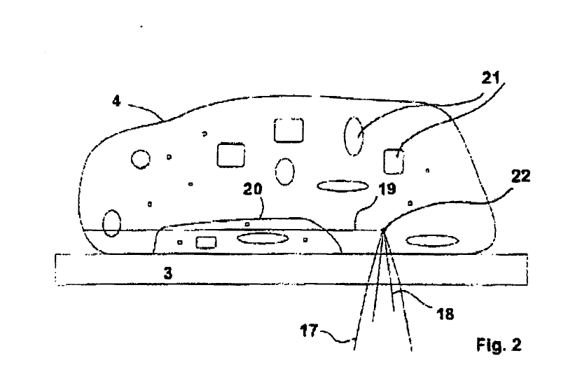

As shown in FIG. 2, the sample 4, held by gravity, lies flush on the glass plate 3. In the sample 4 there are several inclusions 21 which can be gas bubbles, solids of a different consistency, or the like.

The laser beam 11 penetrates the glass plate 3 perpendicular to its plane as a converging beam 17. The convergence of the beam 17 produces the beam focus 22 which causes the material to be severed at one location of the parting plane 19. By sliding the glass plate 3 in one direction perpendicular to the longitudinal axis of the laser beam 11 and 17, the beam focus 22 is moved along the parting surface 19.

The microtome as claimed in the invention moreover enables guidance of the beam focus 22 along a curved parting surface by moving the glass plate 3 in all three directions of space in order for example to produce a hollow, as shown for example as a parting surface 20. In doing so the component of the traversing motion in the direction of the longitudinal axis of the laser beam 11 or 17 can also be attained by changing the convergence/divergence in the prefocussing means 13. To guide the beam focus 22 along the parting surface 20, in this case a traversing motion of the glass plate 3 in two directions of space (XY direction) is combined with a change in the beam focus location in relation to the glass plate 3 in the direction which lies perpendicular to the XY direction by changing the convergence/divergence by means of the prefocussing means 13.

The laser light which is incident on the beam focus 22 by the converging laser beam 17 (arrow A in FIG. 1) is partially reflected by the material of the sample 4 in the area of the beam focus and reflected in the form of a diverging reflection laser beam 18 (arrow B in FIG. 1). The reflection laser beam 18 runs through the focussing objective lens 6 and the prefocussing means 13 in the reverse direction as the laser beam emitted by the laser radiation source on its path to the sample 4. The reflection laser beam 18 can be detected by the OCT detector unit and can be used for display of an image of the sample by means of the process of optical coherence tomography.

In one advantageous embodiment of the microtomy process as claimed in the invention with the microtome as claimed in the invention, a user first defines, for example using an image of the sample 4 which has been obtained by means of the camera 8 or the OCT detector unit 9, the contour of a surface (for example, a rectangle or a circle) and then defines the volume to be cut out by specifying the cutting depth. This volume is then cut out by automatic screening by means of the relative motion of the beam focus along the given surface at the predefined depth and then repeatedly outlining the surface along its edges with simultaneous continued or staggered approach of the beam focus from the depth of the sample to the surface.

1. A microtome comprising:
a holding device with a support (3) for holding at least one portion of a processed object (4),
at least one source of laser radiation (10),
means for focussing (6, 13) of the laser radiation to produce a focussed beam, the beam focus (22) being movable relative to the support (3), and with a capacity to be guided to one location of the parting surface (19, 20) of the processed object (4) in order to cause severing of the material at this location, and
means for pulsed delivery (14) of the focussed beam to the location of the parting surface said pulses having a length of action of <1×10⁻¹² seconds.

2. Microtome as claimed in claim 1, wherein the means for focussing the laser radiation is set up to move the beam focus in at least one direction of space relative to the support.

3. Microtome as claimed in claim 1, further comprising means for guiding (12) the laser radiation to move the beam focus in at least one direction of space relative to the support.

4. Microtome as claimed in claim 1, wherein the means for focussing the laser radiation has a numerical aperture ≧0.65.

5. Microtome as claimed in claim 1, wherein the means for pulsed delivery is set up to interrupt the beam in a pulsating manner and/or to route it away from the location of the parting surface.

6. Microtome as claimed in claim 1, wherein the means for pulsed delivery interacts with the radiation source in order to interrupt the beam in a pulsating manner.

7. Microtome as claimed in claim 1, further comprising control means (14) for
controlling the time sequence of the radiation pauses and/or which are connected to means for detecting the time sequence of the radiation pauses, and/or
controlling the relative motion between the beam focus and the support depending on the time sequence of the radiation pauses.

8. Microtome as claimed in claim 1, further comprising control means for controlling the time sequence of the radiation pauses depending on the relative motion, said control means being connected to means for detecting the relative motion between the beam focus and the carrier.

9. Microtome as claimed in claim 1, further comprising means for controlling relative motion between the support (3) and the beam focus (22) along a curved parting surface (20).

10. Microtome as claimed in claim 1, further comprising means for observing (9, 8, 14, 15, 5, 16) the processed object.

11. Microtome as claimed in claim 10, wherein the observation means comprises an optical microscope which can be operated using the incident light and/or transmitted light process.

12. Microtome as claimed in claim 10, wherein the observation means contains means (9, 14) for displaying at least one portion of the processed object using backscattered laser radiation.

13. Microtome as claimed in claim 12, wherein the display means comprises:
a detector (9) for detection of the radiation which has been backscattered from a portion of the processed object,
means for detecting (9) coherent radiation which has been reflected from a reference plane, and
means for producing (9, 14) an image display of a portion of the processed object by means of superimposition of the laser radiation which has been backscattered from the portion of the processed object and the coherent radiation which has been reflected from the reference plane.

14. Process for microtomy of processed objects (4), comprising the following steps:
holding at least one portion of the processed object by a support (3) of a holding device,
at least partially severing the processed object by a cutting device, wherein
laser radiation (11) is released from a radiation source (10) which is assigned to the cutting device, and
this laser radiation is focussed and the beam focus (22) is routed in a sequence of pulses to a location of the parting surface (19; 22) of the processed object in order to produce material severing at this site, the beam focus (22) relative to the support (3) being moved in two or three directions of space so that the processed object is microtomed.

15. Process as claimed in claim 14, wherein the length of action of a pulse is <1×10⁻¹² seconds.

16. Process as claimed in claim 14, wherein the beam focus is guided along a curved surface (20).

17. Process as claimed in claim 14, wherein the sequence of pulses and the relative motion between the support and the beam focus in time to one another are controlled.

18. Process as claimed in claim 14, wherein the parting surface is predetermined prior to the cutting process and the beam focus is guided automatically along this parting surface.

19. Process as claimed in claim 18, wherein prior to the cutting process an image of at least one portion of the processed object is prepared by means of an optical microscopy imaging process and the parting surface is predetermined using this image.

20. Process as claimed in claim 18, wherein prior to the cutting process an image of at least one portion of the processed object is prepared by means of the process of optical coherence tomography and the parting surface is predetermined using this image.

21. Process as claimed in claim 14, wherein during the cutting process an image of at least one portion of the processed object is prepared by an optical microscopy imaging process and/or the process of optical coherence tomography is prepared and a reproduction of this image is made available to the user, using which he can guide the beam focus.

22. Process as claimed in claim 14, wherein in a first phase of the cutting process one or more regions of the parting surface which are spaced apart from one another are severed and in the last phase of the cutting process complete severing along the parting surface takes place by severing the areas which lie between the spaced regions.

23. (canceled)
